(19) United States
(12) Patent Application Publication
(10) Pub. No.: US 2014/0251383 A1
(43) Pub. Date: Sep. 11, 2014

(54) DEVICE FOR PROVIDING FLUID ACCESS TO THE INTERIOR OF A TUBE, AND SYSTEM, METHOD AND DEVICE FOR TREATING THE INTERIOR OF TUBES

(71) Applicants: EVAN DOMINIC LYLE, Ford City, PA (US); Daniel Curtis Lyle, Kittanning, PA (US)

(72) Inventors: EVAN DOMINIC LYLE, Ford City, PA (US); Daniel Curtis Lyle, Kittanning, PA (US)

(21) Appl. No.: 13/792,141

(22) Filed: Mar. 10, 2013

(51) Int. Cl. B08B 9/032; F28F 27/00

(52) U.S. Cl. CPC B08B 9/0321; F28F 27/00
USPC 134/22.12; 134/166 C; 138/91

(57) ABSTRACT

A treatment system that treats the interior of one or more tubes of a tube bundle. The system circulates treatment fluid within the tubes being treated. A manifold distributes the treatment fluid among the tubes being treated in the case of treatment of more than one tube where the tubes are to be treated simultaneously. A device is provided that both seals the ends of the tubes being treated and forms a passage by which the treatment fluid is introduced into and removed from the tubes. The treatment system can be a tube cleaning system that removes foreign material from the interior of the tubes.

### BACKGROUND OF THE INVENTION

The present invention relates to the flow of fluid through tubes, including the treatment of the interior of tubes.

Many types of equipment employ tubes or tube bundles. It is often necessary to introduce a fluid into the tubes and to remove fluid from the tubes, for a variety of purposes. For example, it is often necessary to treat the interior of these tubes. In many instances, foreign matter builds up on the inner surfaces of the tubes, which degrades performance of the equipment, and must be cleaned to remove the foreign matter.

For example, heat exchangers and other types of condensers, particularly those used in the production of electrical power, develop scale on the interior surfaces of the condenser tubes. This scale impedes heat transfer between the interior of the tubes and the fluid (for example, water or steam) surrounding the tubes, and reduces the efficiency of the power generator. The term “fluid” is used herein to include both gases and liquids. In a typical condenser, for example, the tube bundle is contained with an enclosed condenser box, which affords limited access to the tube bundle. Cleaning the interior walls of the tubes is a challenge, given the difficult access to the interior of the tubes, and the need to accomplish the cleaning as quickly as possible to minimize the down time of the generator.

The current technology employed to clean the interior surfaces of tubes falls broadly into one of three categories: mechanical tube cleaning, hydro-blasting, and chemical cleaning. Each technique is very well known to those in the industry.

Mechanical tube cleaning is generally the fastest method for cleaning deposits from the interior surfaces of tubes. There are numerous types of mechanical tube cleaners, the design of which are based on the type of deposit the device will be removing. Mechanical tube cleaning devices can be used to remove very soft to very hard deposits. Examples of hard deposits are calcium, mostly calcium carbonate, manganese, and silica-based deposits. Mechanical tube cleaning involves propelling a tube cleaner, also known as a scraper, through the tube using a fluid under pressure. As water propels the tube cleaner, deposit is removed by the contact points of the device and then remaining deposit is subsequently flushed out by the water. Mechanical cleaning is generally the most common method because it is fast, cost effective, and the more durable tube cleaning devices are able to remove most deposits. The major disadvantage of this method is that some deposits are so difficult that mechanical cleaning is either not effective or less cost effective than other techniques. For example, a very thick calcium carbonate deposit would be very hard to remove with a mechanical tube cleaner. With such a deposit, it is likely necessary to make multiple passes through the tube with different sized scrapers. The process would begin with a smaller diameter scraper, with subsequent passes being made by scrapers with increasingly larger diameters to progressively scrape layers of scale from the inner tube surface. Depending on the size of the deposit, the mechanical process could be impractical in this case.

Hydro-blasting uses extremely high pressured water to remove deposit from the inner walls of tubes. An operator uses a lance that shoots out high pressured water and manually feeds this lance down each tube. This method can be seen as a substitute to mechanical tube cleaning, but has some significant disadvantages. Generally hydro-blasting takes more time than mechanical tube cleaning and the high pressured water can make this method extremely unsafe for the lance operator.

Chemical cleaning is preferable on small tube bundles (fewer than about 3,000 tubes of average length, typically between 20 to 50 feet in length), or when larger tube bundles have very serious deposits. Broadly, chemical cleaning involves flushing chemicals through the tubes. The chemical comes into contact with scale, and dissolves it. Typically, the entire condenser tube bundle is filled with the chemical. This system uses a re-circulating pump system that includes an inlet hose that forces the chemical from a reservoir into the bundle, and an outlet hose that evacuates the chemical and returns it to the reservoir. The chemical is re-circulated from the reservoir by the pump until the cleaning operation has been completed. New chemical is supplied to the bundle from a separate reservoir either automatically by a pump or manually. Some systems include a pH gauge that monitors the changing pH of the chemical during the cleaning operation. As the chemical dissolves the deposit, the pH of the chemical changes, typically increasing. When the pH of the chemical rises to a predetermined level, another pump begins supplying chemical from a separate reservoir. Also typically, the predetermined pH level of the system can be set within a range. While this system is effective in removing deposits from the tubes, it is expensive primarily due to the cost of the chemical required to completely fill the tube bundle.

### BRIEF SUMMARY OF THE INVENTION

The present invention provides a device for providing fluid access to the interior of a tube, and a system, method and device for circulating fluid through tubes. The system can be used for treating the interior surface of one or more tubes, and utilizes a sealing device of the type provided by the present invention that seals the ends of the tube while permitting the fluid to enter and exit the tube. The system can be used to force a chemical liquid through the tube to remove scale from the interior surfaces of the tube. The system can be used to treat individual tubes or multiple tubes. Entire sections of a tube bundle can be treated. The system provided by the present invention is particularly useful for cleaning scale from the interior of tubes, like those in the tube bundle of a condenser or heat exchanger, using a chemical cleaning fluid. The sealing device can be used to introduce fluid into a tube, and allow for removal of the fluid from the interior of a tube for any purpose, including cleaning or descaling the interior surface walls of the tube.

The sealing device provided by the present invention includes an inlet for receiving fluid, an outlet, a fluid passage adapted to permit flow of the fluid between the inlet and the outlet, and a seal adapted to prevent flow of the fluid between the sealing device and the interior of the tube. A first sealing device may be mounted within a first end of a tube and a second sealing device may be mounted within a second end of the tube to permit the fluid to pass through the tube. In a preferred embodiment of the invention, the sealing device provides a seal between the device and the tube wall utilizing a sealing material that can be expanded under pressure to force the sealing material against the interior surface of the tube to provide a seal against fluid leaking from the tube, and against foreign matter entering the tube from the exterior of the tube. Preferably, the sealing material is expanded against the inner surface of the tube using a nut and bolt assembly provided with the sealing device that compresses the sealing material. Also preferably, the sealing material is at least one sealing sleeve. In most applications, two sealing sleeves are preferred.

A treatment system provided by the present invention is used to treat the interior surfaces of at least one tube with a treatment fluid. The treatment system can be used to remove scale from the inner surfaces of tubes by forcing a chemical through the tube.

The system includes a supply of treatment fluid, a feed that provides treatment fluid from the supply to the tube, a return that recirculates treatment fluid to the supply after it has passed through the tube, and a sealing device of the type provided by the present invention. The sealing device establishes fluid communication between the supply and the interior of the tube. The device includes an inlet and an outlet, a fluid passage adapted to permit flow of the treatment fluid between the inlet and the outlet, and a seal adapted to prevent flow of the fluid between the device and the interior of the tube, and to prevent foreign matter from entering the tube from the exterior of the tube.

The treatment system can be used to isolate a section comprising multiple tubes to clean more than one tube of the tube bundle while bypassing sections that do not need to be cleaned. In this instance, a sealing device is mounted in the inlet and outlet ends of the tubes being cleaned, and manifolds are provided that are in fluid communication with the inlets and outlets of the tubes being cleaned. As is known in the art, the manifolds distribute the treatment fluid to and from the tubes being treated.

The system provided by the present invention can be configured in a number of ways to treat a section comprising multiple tubes. For example, a section of six tubes can be treated by configuring the system in a “multiple loop” configuration. In a multiple loop configuration, pairs of tubes are coupled to allow treatment fluid to enter a first tube of the pair, exit the first tube and enter the second tube. The fluid is returned to the system upon exiting the second tube. In this configuration, the system defines three independent flow loops. Alternately, a system can be provided that employs a “continuous loop” configuration. In a continuous loop configuration, the tubes are coupled to form a single flow path for the treatment fluid. The outlets and inlets of the tubes are coupled to form the flow path. With the “multiple loop” and the “continuous loop” configurations, the pump and fluid treatment reservoir could be completely contained within the condenser box. In that case, all hoses that are used to connect the tubes with the pumping system are also located within the condenser box.

The system also can employ an “individual loop” configuration. In an individual loop configuration, each tube forms an independent flow path to and from the system supply. In an individual loop configuration, the inlet of each tube receives treatment fluid from the supply through a single inlet, and returns fluid to the supply through a single outlet. This configuration includes a hose that runs from the pumping system to an inlet manifold that distributes the treatment fluid to the inlet of each tube, and an outlet manifold on the outlet side of the of the tube bundle that collects the treatment fluid after it passes through and exits the tubes, and returns it to the pumping system.

Other configurations, including combinations of these configurations, can be employed.

The method provided by the present invention includes the steps of providing a supply of treatment fluid, feeding treatment fluid from the supply to the tube, returning treatment fluid to the supply after it has passed through the tube, and providing fluid access to the interior of the tubes using a device that includes an inlet and an outlet, a fluid passage adapted to permit flow of the treatment fluid between the inlet and outlet, and a seal adapted to prevent flow of the fluid between said device and the exterior of the tube.

### BRIEF DESCRIPTION OF THE SEVERAL VIEWS OF THE DRAWINGS

The following detailed description of the preferred embodiments may be understood better if reference is made to the appended drawing, in which:

FIG. 1 is a graphic depiction of a tube bundle, of the type used in condensers;

FIG. 2 is a side view of the bundle shown in FIG. 1, depicting either the inlet or outlet of the tube bundle;

FIG. 3 is a graphic representation showing a system provided by the present invention installed to clean part of a tube bundle of the type shown in FIGS. 1 and 2;

FIG. 4 is a graphic representation showing a system provided by the present invention installed to clean a pair of tubes of the bundle shown in FIGS. 1 and 2;

FIG. 5 shows a system provided by the present invention for treating a section of six tubes of the bundle shown in FIGS. 1 and 2, in a multiple loop configuration;

FIG. 6 is a side view of the equipment shown in FIG. 5

FIG. 7 is a side sectional view of a sealing plug provided by the present invention;

FIG. 8 is a side section view of the sealing plug shown in FIG. 7 mounted to a tube, with an endpiece mounted to the sealing plug, and a coupling and hose mounted to the endpiece;

FIG. 9 shows a system provided by the present invention for treating a section of six tubes of the bundle shown in FIGS. 1 and 2, in an individual loop configuration;

FIG. 10 is a side view of the equipment shown in FIG. 9;

FIG. 11 shows a system provided by the present invention for treating a section of six tubes of the bundle shown in FIGS. 1 and 2, in a continuous loop configuration;

FIG. 12 is a side view of the equipment shown in FIG. 11;

FIG. 13 is an exploded view of the sealing plug shown in FIG. 7; and

FIG. 14 is a perspective view of the sealing plug shown in FIG. 13.

### DETAILED DESCRIPTION OF EMBODIMENTS

The preferred embodiments of the present invention shown in the drawing are particularly useful for chemically cleaning scale from the inner surfaces of condenser and heat exchanger tubes. However, the present invention can be used to deliver any type of fluid to the interior of tubes for any purpose. Further, the present invention, including the embodiments shown in the drawing, can be used to treat tubes singly or together in a section of a tube bundle.

When used as a chemical cleaning system to, for example, clean the interior of condenser tubes, the system can employ any type of chemical cleaning fluid currently used to clean scale and deposits from the inner surfaces of condenser tubes. Chemical cleaning of condenser tubing is a well-known and established industry, and the chemicals that can be used in the cleaning process are very well known. For example, the chemical sold for this purpose by Apex Engineering Products Corporation, of Aurora, Ill., (“Apex”) under the trademark RYDLYME® works well and can be used with the present invention. Similarly, the manifolds, fluid supply reservoirs, pH sensors, control circuits and pumps used in current chemical cleaning systems are well known. Examples are the pumping system components sold by Apex and Goodway Technologies Corporation of Stamford, Conn. Consequently, those components of the system will not be described in detail herein.

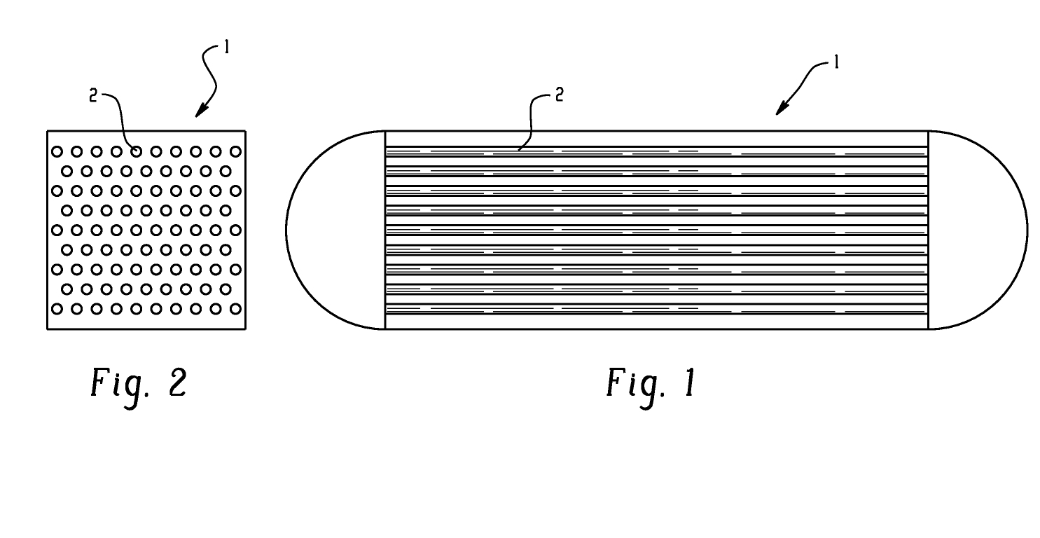

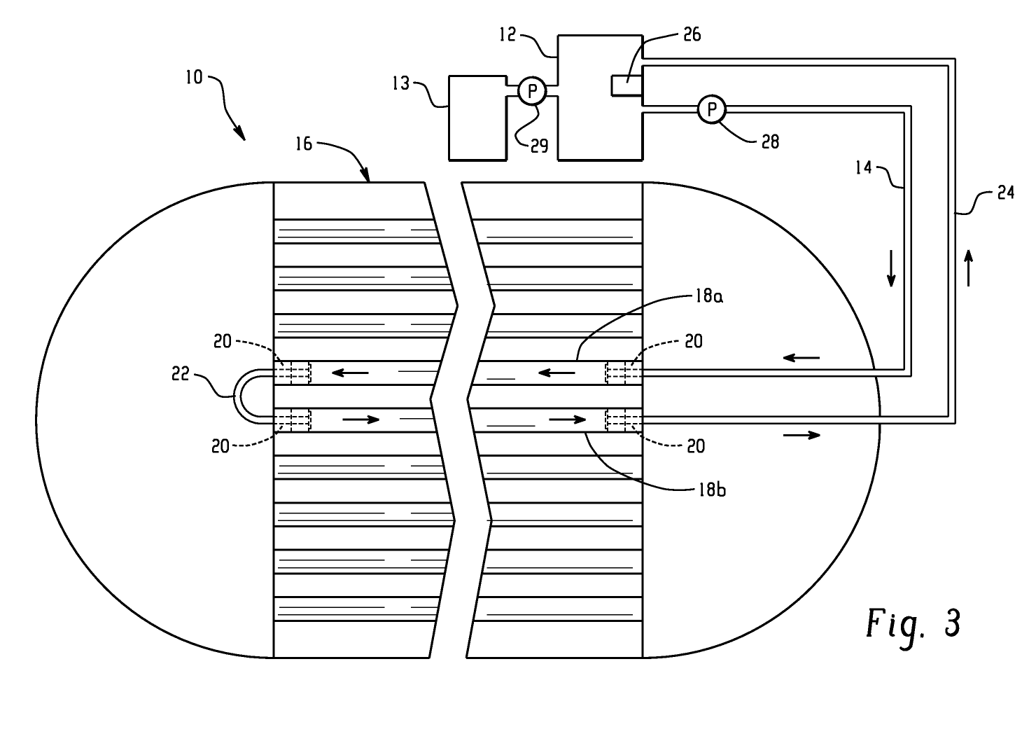

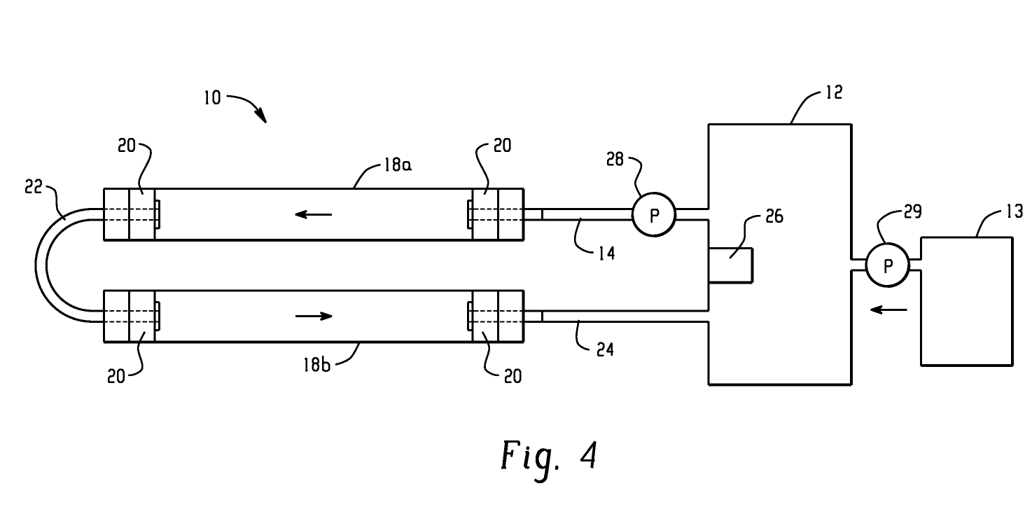

FIGS. 1 and 2 are graphic representations of a tube bundle 1 of a condenser that can be cleaned by the preferred embodiments described herein. Tube bundle 1 is composed of a number of individual tubes 2. During use of the condenser, as is well known, the interior surfaces of tubes 2 become coated with a scale or deposits. The scale degrades the heat transfer capabilities of tubes 2, and must be removed. FIGS. 3 and 4 show a system 10 provided by the present invention that can be used to remove the scale, as well as other foreign material, from the inner surfaces of tubes 2.

System 10 includes a reservoir 12 that contains a chemical, of any known type, that removes scale from condenser tubes. A feed 14, consisting of an inlet line of any known desirable type, is provided to deliver chemical fluid from reservoir 12 to tube bundle 16. FIGS. 3 and 4 show system 10 configured to clean a pair of adjacent tubes 18a and 18b. Four sealing plugs 20 are used to seal the ends of tubes 18 and permit the passage of cleaning fluid to and from tubes 18a and 18b. A U-connector 22 is provided between two of sealing plugs 20 to allow cleaning fluid to flow from the first tube 18a to the second tube 18b. Return 24 is installed between the sealing plug 20 that seals the outlet of tube 18b and reservoir 12 to permit the cleaning fluid to be recycled to reservoir 12 after it has made a pass through tubes 18a and 18b. A pump 28 is employed to circulate chemical cleaning fluid from reservoir 12 throughout system 10. A pH sensor 26 can be provided to measure the pH of the cleaning fluid as it is reused. As the cleaning fluid is recycled through system 10, its pH rises as it reacts with the scale within tubes 18a and 18b. As the pH of the cleaning fluid rises, it becomes less effective to react with and dissolve the scale within tubes 18a and 18b. Sensor 26 can be set to provide an indication that a predetermined pH level has been reached, at which point a fresh supply of cleaning fluid can be provided from reservoir 13 to system 10, either manually by dumping new chemical into reservoir 12 or automatically by having the pH gauge trigger pump 29 to pump new chemical into reservoir 12.

In use, pump 28 forces cleaning fluid from reservoir 12 into feed 14 and into tube 18a via a sealing plug 20. As the cleaning fluid flows through tube 18a, it reacts with scale on the inner surface of tube 18a, dissolving at least some of it. The fluid exits tube 18a through another sealing plug 20, passes through U-connector 22, and enters tube 18b through a third sealing plug 20. As with tube 18a, the cleaning fluid reacts with scale on the inner surface of tube 18b as it flows through it, dissolving some of the scale as it does so. The cleaning fluid exits tube 18b through a fourth sealing plug 20, enters return 24 and is pumped back into reservoir 12, from which it is recirculated until its pH, as measured by sensor 26, has risen to a predetermined level. At this point, new cleaning fluid is introduced into system 10 from reservoir 13, either manually or automatically through pumping system 29.

FIG. 3 shows a system 10 that cleans two tubes 18a and 18b. However, it can be seen that system 10 can be configured to clean a single tube, or a section of tubes of any number.

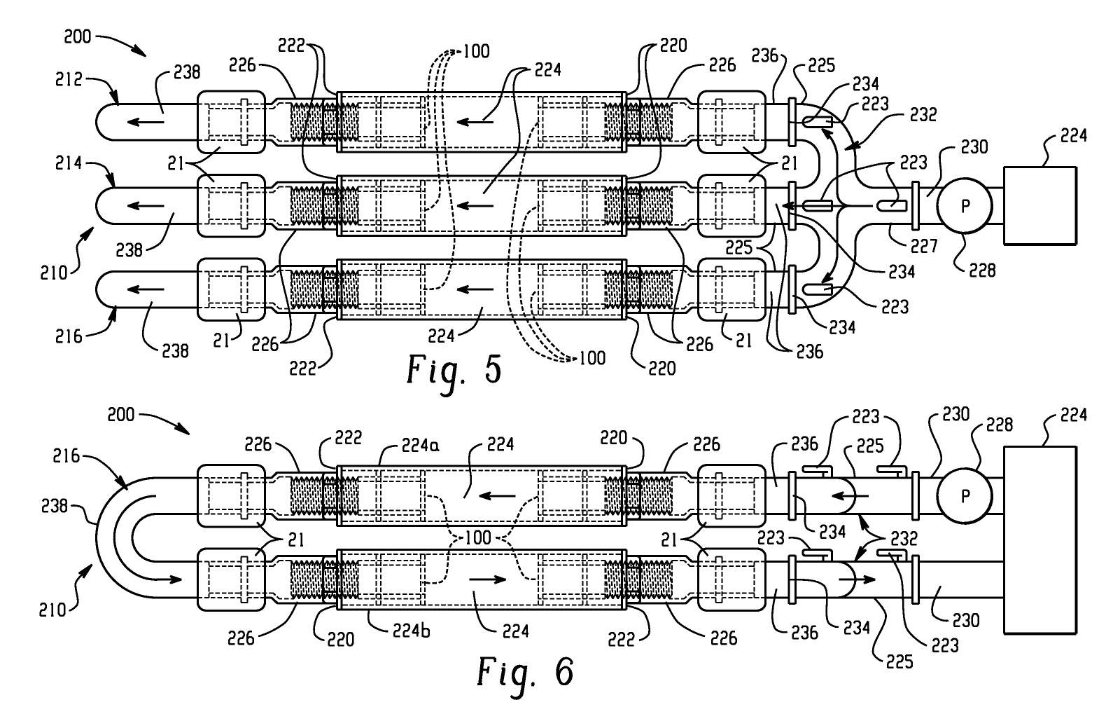

For example, FIGS. 5 and 6 show a system 200 that is used to clean a section 210 of 6 tubes 224. System 200 is configured in a “multiple loop” configuration. That is, system 200 includes three independent flow paths through section 210. Each of tube pairs, or loops, 212, 214 and 216 carries an independent flow path. Each tube 224 of loops 212, 214 and 216 defines an inlet 220 and an outlet 222. A plug 100 is sealingly mounted in each inlet 220 and each outlet 222. The construction of plugs 100 is described in detail below. Each plug 100 defines a central passage through which fluid can flow through plug 100 and into or out of a tube 224. An endpiece 226 is threaded onto the end of each plug 100 to facilitate connection between the inlet 220 or outlet 222 with connecting lines or hoses. Each endpiece 226 can be secured to its respective line using a conventional connector 21. Connector 21 can be any known connector that is used to mount hardware to hoses, including the type used with compressed air hoses. These connectors use a sliding outer sleeve and ball bearings to attach the hose to a head. Connector 21 can be used in all embodiments of the system shown in the drawing.

System 200 includes a pump 228 that pumps fluid from a reservoir 224 through system 200. A pair of hoses 230 carries fluid pumped by pump 228. Hoses 230 are mounted to a manifold 232. Manifold 232 defines outlets 234, each of which is mounted to an inlet hose 236. Each hose 236 is mounted to an endpiece 226. Ball valves 223 are mounted in known fashion within each manifold inlet 225 and manifold main inlet 227 to prevent unintended reverse flow. Consequently, pump 228 pumps fluid into hoses 230, through manifold 232, through hoses 236 and endpieces 226, and through plugs 100 into the interior of tubes 224.

A U-shaped connecting hose 238 is mounted to the endpiece 226 mounted to the outlet 222 of an inlet pipe 224a of each loop 212, 214 and 216 and the endpiece 226 mounted to the inlet 220 of the outlet tube 224b of the loop. As a result, fluid pumped through the inlet tube 224a of each loop 212, 214 and 216 exits an outlet 222, through connecting hose 238 and into outlet tube 224b. The fluid then flows through outlet tube 224b, plug 100, endpiece 226, hose 236, manifold 232, hose 230 and back to reservoir 224 and re-circulated through pump 228.

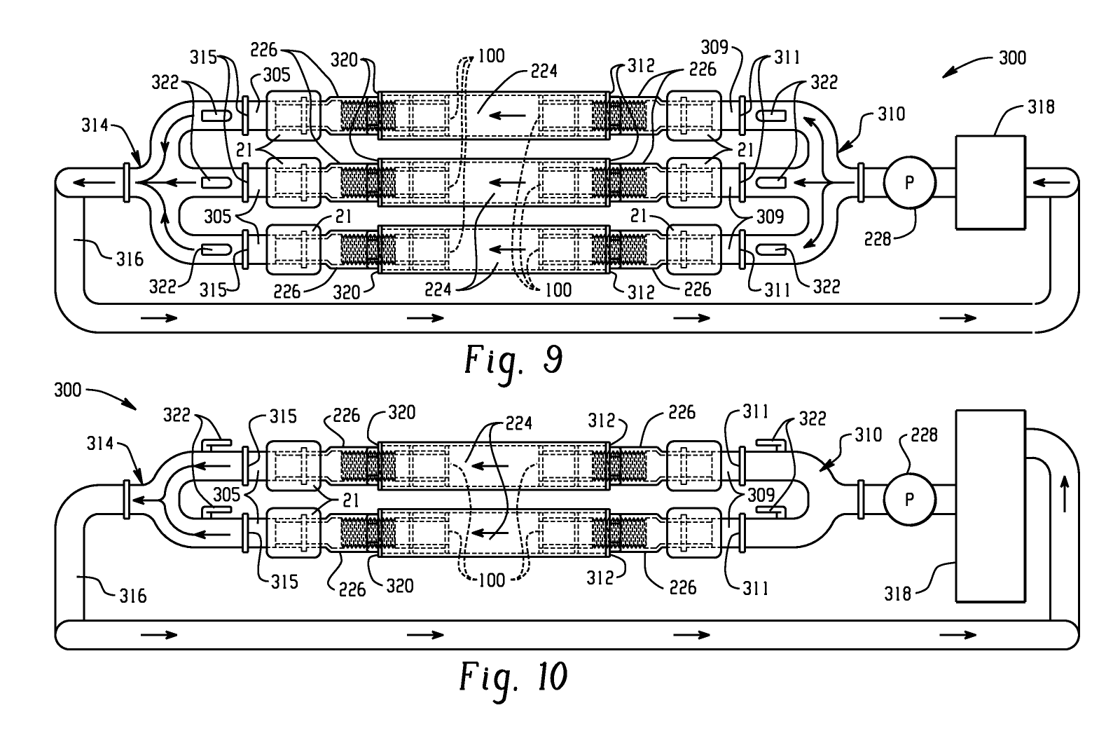

FIGS. 9 and 10 show a system 300 that is constructed in an “individual loop” configuration. The construction of system 300 is identical to the construction of system 200, with the exception of the flow paths defined by system 300. Rather than configuring pairs of tubes connected by U-shaped hoses to define flow paths, system 300 is configured to define a flow path corresponding to each tube. Thus, system 300 utilizes an inlet manifold 310 defining inlets 311. Inlets 311 are connected to endpieces 226 via hoses 309 and couplings 21, which are used to mount hoses 309 to endpieces 226. Manifold 310 is used to distribute fluid to the inlets 312 of tubes 224 via plugs 100. System 300 includes an outlet manifold 314 that defines outlets 315 that are connected to the end pieces 226 of the plugs 100 that are mounted to the outlets 320 of the tubes 224. Outlets 315 are mounted to endpieces 226 via hoses 305 and couplings 21, which are used to mount hoses 305 to endpieces 226. Ball valves 322 are mounted in known fashion within each manifold inlet 311 and manifold outlet 315 to prevent unintended reverse flow. Manifold 314 collects fluid that has passed through tubes 224, and directs the fluid through a single return line 316 back to the fluid reservoir 318. Typically, line 318 is located outside the containment box (not shown) of the condenser. Consequently, fluid is pumped by pump 228 through inlet manifold 310, tubes 224, outlet manifold 314, return line 316 and back to reservoir 318.

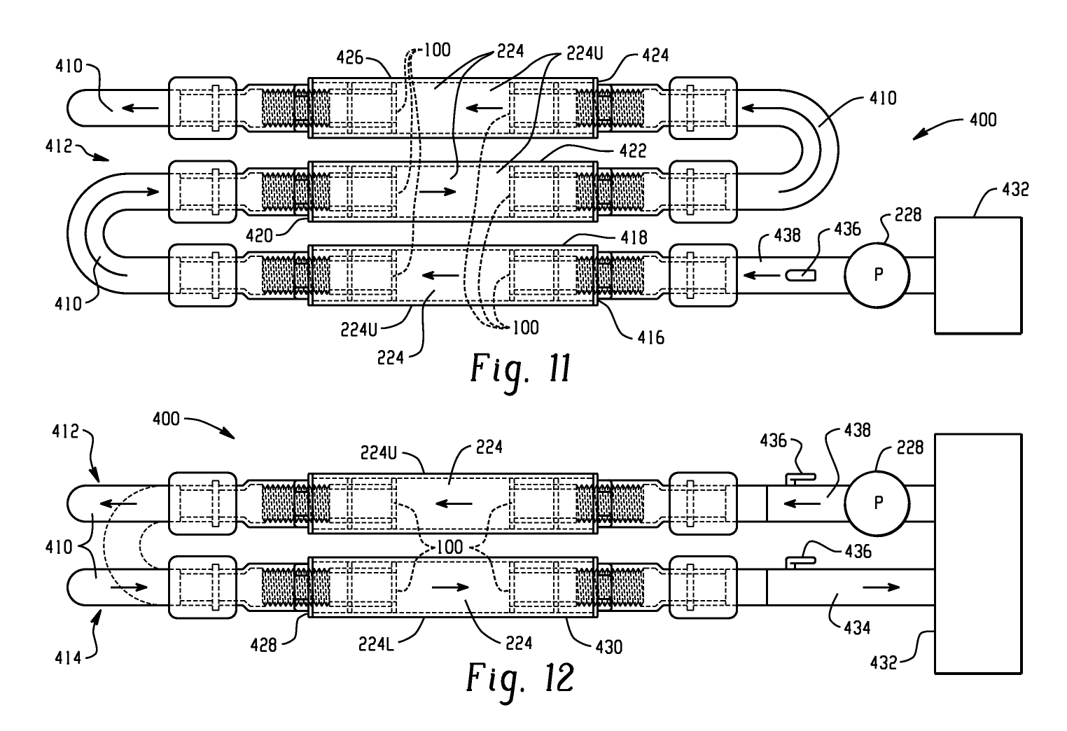

Similarly, FIGS. 11 and 12 show a system 400 that is identical in construction to systems 200 and 300, with the exception of the manner in which the flow path is defined. System 400 is constructed in a “continuous loop” configuration. System 400 defines a single flow path through tubes 224. In other words, fluid flows through the tubes 224 of system 400 in completely “series” fashion. All fluid pumped through system 400 flows through all the tubes of the section being treated. A U-shaped connector 410 is employed to channel the flow through adjacent tubes 224. To illustrate, FIGS. 11 and 12 show system 400 defining two rows, or layers, of tubes, upper row 412 and lower row 414. System 400 pumps fluid serially through tubes 224U of upper row 412, and then through the tubes 224L of lower row 414. Pump 228 pumps fluid into the inlet 416 of first tube 418. Fluid flows through tube 418 and into a connector 410 that directs the fluid into inlet 420 of second tube 422. A second connector 410 directs fluid exiting tube 422 into the inlet 424 of a third tube 426. A third connector 410 directs the fluid downwardly to the inlet of the first tube (not shown) of the lower row 414. As with upper layer 412, another U-connector (not shown) directs the fluid to the second tube (not shown) of row 414. Finally, a fifth connector 410 directs the fluid to the inlet 428 of the sixth, and last, tube 430. The fluid is returned to the fluid reservoir 432 via line 434. As is well known in the industry, ball valves 436 are provided in lines 438 and 434 to prevent reverse flow.

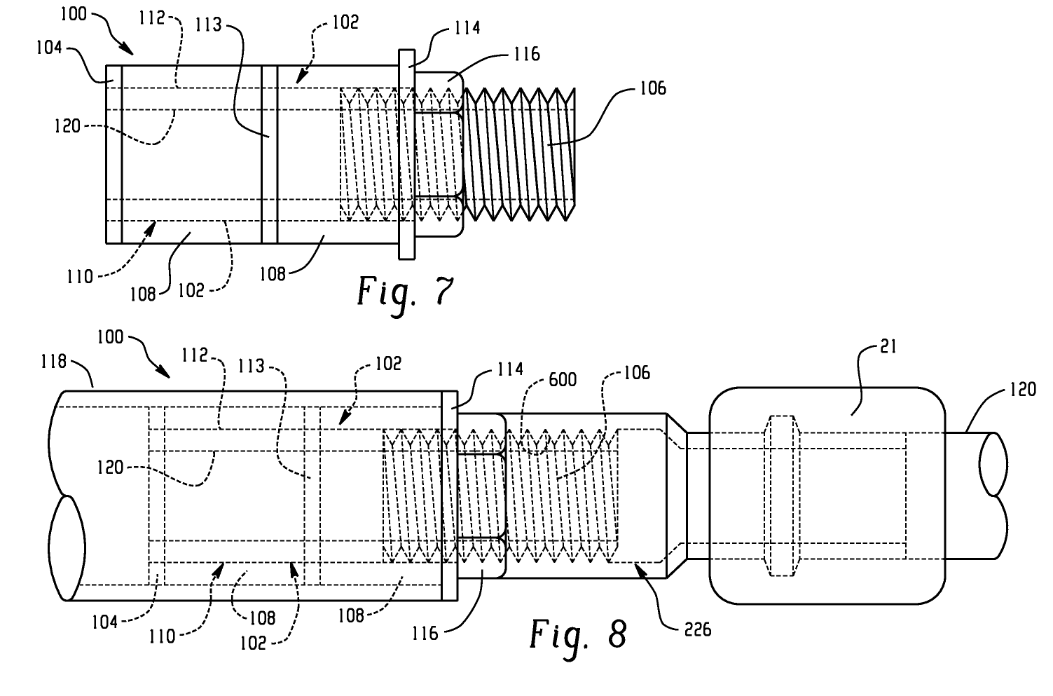

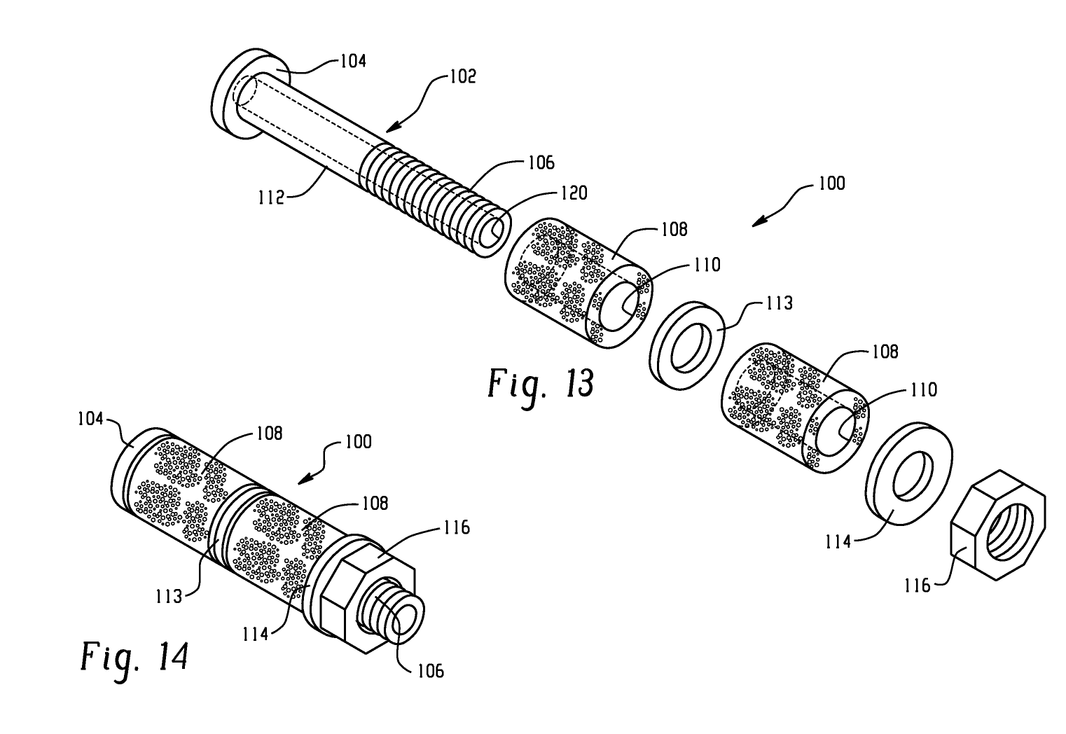

Referring to FIGS. 7, 8, 13 and 14 a sealing plug 100 provided by the present invention can be used to seal the ends of tubes to provide fluid access to the interior of a tube. Sealing device 100 can be used in systems that circulate cleaning fluid through tubes to clean the interior surfaces of the tubes. As is described above, sealing device 100 can be used in systems of the type shown in the drawing, and to allow passage of the cleaning fluid into and out of the tubes. It should be understood, however, that plug 100 can be used in any system that introduces a fluid into tubes for any purpose.

Plug 100 includes a threaded core 102 made from a suitable plastic or metal material, such as plastic: Delrin or acetal 570 or metal: stainless steel. Core 102 defines a flange 104 at one end, and a threaded section 106 at the other end. At least one cylindrical sealing sleeve 108 is provided, which defines a central bore 110, which is sized to be received along central section 112 of core 102. At least one sleeve 108 is mounted on section 112 of core 102. If more than one sleeve 108 is used, a plastic washer 113 is mounted between each pair of sleeves 108. Where, as with the embodiment shown in the drawing, a pair of sleeves 108 is employed, a single washer 113 is mounted between sleeves 108. Regardless of the number of sleeves 108 employed, a washer 114 is mounted on core 102 adjacent the end of the outermost sleeve 108. Washer 113 will have a smaller diameter than 114 to enable the diameter of washer 113 to more closely match the diameter of sleeves 108. A nut 116 is threaded onto the threaded end 106 of core 102, and bears against washer 114. The diameter of washer 114 is chosen to be larger than the inner diameter of the tubes in which plug 100 is mounted to facilitate placement of plug 100 in a consistent location with respect to the tubes. That is, washer 114 acts like a “stop” that prevents inadvertent placement of plug 100 to far within the tube. Washers 113 and 114 function as the bearing surfaces against which the force generated by nut 116 is exerted against the ends of sleeves 108, which in turn operates to expand sleeves 108 and force them into sealing engagement with the interior of tube 118 (see, particularly, FIG. 8). The expansion of the sleeves 108 against the interior surface of tube 118 also operates to fix the position of plug 100 within tube 118.

Core 102 defines a passage 120 through which fluid can pass through core 102. Endpiece 226 includes a threaded section 600 which is threaded onto threaded section 106 of plug 100 to mount endpiece 226 to plug 100. A hose or line 120 can then be mounted to endpiece 226 using a conventional coupling 21.

To mount a plug 100 within a tube 118, a sleeve 108 is mounted onto center section 112 of plug 100. The length of section 112 and the number of sleeves 108 can vary. The length of section 112 will typically be between three and four inches and plug 100 will typically have one washer 113 separating two flexible bushings or sleeves 108 and an additional washer 114 separating sleeves 108 and nut 116, which will typically provide an effective seal. These configurations can be changed to alter the nature of the seal as is well known in the art. Generally, the effectiveness of the seal between the plug 100 and a tube increases as the number of washers 113 increases and the length of the bushings 108 decreases. However, as will be appreciated by those in the art, the increased number of washers 113 will begin to compromise the effectiveness of the seal. A plug with two sealing sleeves 108 separated by a washer 113 will provide an effective seal in most situations. If it is found that the seal is not adequate, those in the art will appreciate how to modify the number and length of the sleeves 108 to improve the seal. For example, if a tube is severely eroded and, consequently, achieving a seal is difficult, the plug 100 may need to be made longer or more washers 113 will need to be added, which would mean more, and shorter, sleeves 108 would be provided on the plug 100.

Flange 104 is inserted into a tube 118 that is to be cleaned, and a nut 116 is threaded onto threaded end 106 of plug 100. As nut 116 is tightened, sleeves 108 expand radially to provide a seal between plug 100 and the interior of tube 118. In this regard, the washers 114 provide bearing surfaces for the pressure exerted on sleeves 108 by nut 116, and ensure more uniform expansion of sleeves 108. When plugs 100 are fully mounted to each end of tube 118, fluid is free to pass into and out of tube 118.

Although the invention has been described with reference to the above embodiments, it will be apparent to one of the ordinary skill in the art that modifications to the described embodiments may be made without departing from the spirit or scope of the invention. For example, it is to be understood that changes may be made in details, including in matters of shape, size, and arrangement of parts in accordance with the appended claims. The foregoing description of embodiments of the invention have been presented only for purposes of illustration and description. These embodiments were chosen and described to best explain the principles of the invention and its practical applications to thereby enable others skilled in the art to best utilize the invention in various embodiments and with various modifications as are suited to the particular uses contemplated. Accordingly, the scope of the invention will be defined by the attached claims not by the above detailed descriptions.

What is claimed is:

1. A device used in connection with a system that circulates fluid within the interior of at least one tube, comprising:
an inlet for receiving the fluid from the system;
an outlet;
a fluid passage adapted to permit flow of the fluid between said inlet and said outlet; and
a seal adapted to prevent flow of the fluid between said device and the interior of the tube;
whereby a first said device may be mounted within a first end of a tube and a second said device may be mounted within a second end of the tube to permit the system to pass fluid through the interior of the tube.

2. The device recited by claim 1 wherein the system employs a chemical to remove foreign matter from the interior surface of the tube.

3. The device recited by claim 2 wherein said seal includes a sealing material that can be expanded under pressure to force said sealing material against the interior surface of the tube.

4. The device recited by claim 3 wherein said sealing material is expanded using a nut and bolt assembly.

5. A treatment system for treating the interior of at least one tube with a treatment fluid, comprising:
a supply of treatment fluid;
a feed that provides treatment fluid from said supply to the tube;
a return that returns treatment fluid to said supply after it has passed through the tube; and
a device for establishing fluid communication between said supply and the interior of said tube, said device including an inlet and an outlet, a fluid passage adapted to permit flow of the treatment fluid between said inlet and said outlet, and a seal adapted to prevent flow of the fluid between said device and the interior of the tube.

6. The treatment system recited by claim 5 wherein said treatment fluid is a cleaning fluid used to remove foreign matter from the interior of the tube.

7. The treatment system recited by claim 5 wherein said treatment system is used to clean the interior surface of one or more tubes of a tube bundle.

8. The treatment system recited by claim 7 wherein said system can clean more than one tube of the tube bundle at a time and a said device is mounted in the inlet and outlet ends of the tubes being cleaned.

9. The treatment system recited by claim 8 wherein said treatment system further includes manifolds that are in fluid communication with the inlets and outlets of the tubes being cleaned, said manifolds distributing said treatment fluid to or from the tubes being treated.

10. A method for treating the interior of at least one tube with a treatment fluid, comprising the steps of:
providing a supply of treatment fluid;
feeding treatment fluid from said supply to the tube;
returning treatment fluid to said supply after it has passed through the tube; and
providing fluid access to the interior of the tubes using a device that includes an inlet and an outlet, a fluid passage adapted to permit flow of the treatment fluid between said inlet and said outlet, and a seal adapted to prevent flow of the fluid between said device and the interior of the tube.
